(19) United States
(12) Patent Application Publication
(10) Pub. No.: US 2019/0355071 A1
(43) Pub. Date: Nov. 21, 2019

(54) MANAGEMENT SERVER, INFORMATION PROCESSING METHOD, AND INFORMATION PROCESSING SYSTEM

(71) Applicant: TOYOTA JIDOSHA KABUSHIKI KAISHA, Toyota-shi (JP)

(72) Inventors: Nariaki AMANO, Tokyo-to (JP); Naoki YAMAMURO, Nagoya-shi (JP); Masato ENDO, Nagakute-shi (JP); Yukiya YAMANE, Tokyo-to (JP)

(73) Assignee: TOYOTA JIDOSHA KABUSHIKI KAISHA, Toyota-shi (JP)

(21) Appl. No.: 16/416,670

(22) Filed: May 20, 2019

(30) Foreign Application Priority Data
May 21, 2018 (JP) 2018-097060

(51) Int. Cl. G06Q 50/06; G06Q 30/02; B60L 53/66

(52) U.S. Cl. CPC G06Q 50/06; G06Q 30/0283; B60Y 2300/91; B60Y 2200/91; B60L 53/665

(57) ABSTRACT

In a management server, a first acquirer acquires a use condition for each of multiple electric outlets. An identification unit identifies an electric outlet through which electricity is supplied to a vehicle of a user. A second acquirer acquires charge result information of the vehicle charged up with electricity supplied through the identified electric outlet. A deriver derives at least one of an amount of payment to a manager of the installation place of the identified electric outlet and an amount charged to the user, based on the use condition for the identified electric outlet acquired at the first acquirer and the charge result information acquired at the second acquirer.

The disclosure of Japanese Patent Application No. 2018-097060 filed on May 21, 2018 including the specification, drawings and abstract is incorporated herein by reference in its entirety.

### BACKGROUND

### 1. Technical Field

The present disclosure relates to a management server, an information processing method, and an information processing system for managing information regarding electricity trade.

### 2. Description of Related Art

There are known systems that enable drivers of electric vehicles to charge up the batteries of their electric vehicles using electric outlets installed in houses or stores where they are visiting. JP-A-2010-079456 discloses an electricity bill charging system in which a center device notifies an electricity supplier having a contract with the owner of a vehicle, of information on the amount of electricity supplied to the vehicle through an electric outlet at an electricity supply place. In this system, the owner of the vehicle is directly charged a fee corresponding to the amount of electricity supplied to the vehicle, and a manager of the electricity supply place is charged a fee for a difference amount of electricity calculated by subtracting the amount of electricity supplied to the vehicle.

The inventors have found that, since each manager has a different reason for installing an electric outlet, each manager may desire to determine the fee for use of the electric outlet. It is also found that a provider of a battery charging service may also desire to determine the fee for use of an electric outlet.

### SUMMARY

A general purpose of the present embodiments is to provide a management server, an information processing method, and an information processing system capable of appropriately performing at least one of payment to a manager and charging to a user, in response to the desire of the manager and according to a use condition for an electric outlet set by the manager.

In response to the above issue, a management server of one aspect of the present embodiments includes: a first acquirer configured to acquire a use condition for each of a plurality of electric outlets; an identification unit configured to identify an electric outlet through which electricity is supplied to a vehicle of a user; a second acquirer configured to acquire charge result information of the vehicle charged up with electricity supplied through the identified electric outlet; and a deriver configured to derive at least one of an amount of payment to a manager of the installation place of the identified electric outlet and an amount charged to the user, on the basis of the use condition for the identified electric outlet acquired at the first acquirer and the charge result information acquired at the second acquirer.

According to this aspect, since at least one of the amount of payment to the manager and the amount charged to the user is derived based on the use condition for the electric outlet and the charge result information, at least one of the payment to the manager and the charging to the user can be appropriately performed according to the use condition set by the manager, for example.

When the use condition for the identified electric outlet has been set by the manager, the deriver may derive the amount of payment to the manager and the amount charged to the user on the basis of the use condition and the charge result information.

The management server may further include a third acquirer configured to acquire contract information regarding electricity supply between an electricity supplier for supplying electricity to the identified electric outlet and the manager. When the use condition for the identified electric outlet has been set by an owner of the management server, the deriver may derive the amount charged to the user on the basis of the use condition and the charge result information, and also may derive the amount of payment to the manager on the basis of the contract information acquired at the third acquirer and the charge result information.

The use condition may include a unit price used for charging to the user and set for each time period.

The management server may further include a communication unit configured to transmit the use condition for an electric outlet specified by the user, to a user terminal owned by the user, and a control unit configured to permit electricity supply through the electric outlet when the communication unit receives, from the user terminal, agreement information regarding the user's agreement to the use condition.

Another aspect of the present embodiments relates to an information processing method. The information processing method includes: first acquiring of acquiring a use condition for each of a plurality of electric outlets; identifying an electric outlet through which electricity is supplied to a vehicle of a user; second acquiring of acquiring charge result information of the vehicle charged up with electricity supplied through the identified electric outlet; and deriving at least one of an amount of payment to a manager of the installation place of the identified electric outlet and an amount charged to the user, on the basis of the use condition for the identified electric outlet acquired in the first acquiring and the charge result information acquired in the second acquiring.

According to this aspect, since at least one of the amount of payment to the manager and the amount charged to the user is derived based on the use condition for the electric outlet and the charge result information, at least one of the payment to the manager and the charging to the user can be appropriately performed according to the use condition set by the manager, for example.

Yet another aspect of the present embodiments relates to an information processing system. The information processing system includes a plurality of electricity supply devices, and a management server configured to communicate with the plurality of electricity supply devices. Each of the plurality of electricity supply devices includes an electric outlet supplied with electricity from an electricity supplier, and a control device configured to record charge result information of a vehicle of a user charged up with electricity supplied through the electric outlet. The management server includes: a first acquirer configured to acquire a use condition for each of a plurality of electric outlets of the plurality of electricity supply devices; an identification unit configured to identify an electric outlet through which electricity is supplied to the vehicle; a second acquirer configured to acquire the charge result information from the control device for the identified electric outlet; and a deriver configured to derive at least one of an amount of payment to a manager of the installation place of the identified electric outlet and an amount charged to the user, on the basis of the use condition for the identified electric outlet acquired at the first acquirer and the charge result information acquired at the second acquirer.

According to this aspect, since at least one of the amount of payment to the manager and the amount charged to the user is derived based on the use condition for the electric outlet and the charge result information, at least one of the payment to the manager and the charging to the user can be appropriately performed according to the use condition set by the manager, for example.

The management server may further include a communication unit configured to transmit the use condition for an electric outlet specified by the user, to a user terminal owned by the user. When the communication unit transmits the use condition, the control device may start electricity supply through the electric outlet upon electrical connection of the vehicle to the electric outlet.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram that shows a configuration of an information processing system according to a first embodiment;

FIG. 2 is a diagram that shows a configuration of a management server shown in FIG. 1;

FIG. 3 is a sequential diagram that shows processing performed in the information processing system shown in FIG. 1; and

FIG. 4 is a diagram that shows a configuration of the management server according to a second embodiment.

### DETAILED DESCRIPTION

Various embodiments now will be described. The embodiments are illustrative and are not intended to be limiting.

### First Embodiment

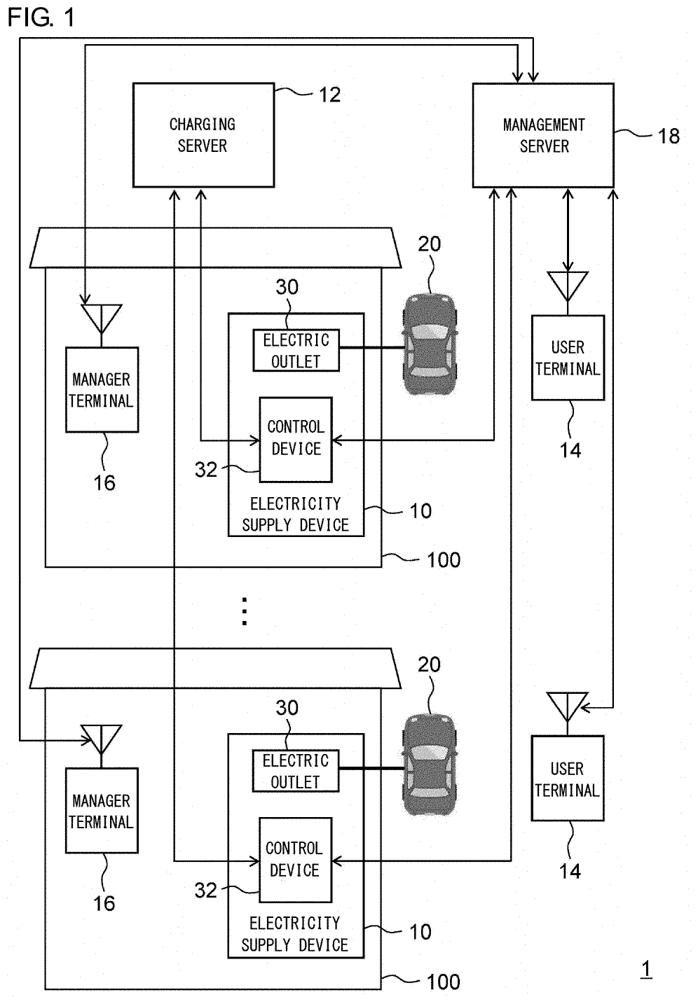

FIG. 1 shows a configuration of an information processing system 1 according to the first embodiment. The information processing system 1 includes multiple electricity supply devices 10, a fee charging server 12, multiple user terminals 14, multiple manager terminals 16, and a management server 18.

Each electricity supply device 10 may be installed in a store, a house, a company, a parking area, and other facilities, for example, and is capable of supplying electricity to a vehicle 20 owned by one of multiple users registered in advance in the management server 18. The electricity supply devices 10 are also called authentication outlets. Each electricity supply device 10 includes an electric outlet 30 and a control device 32. A facility where an electricity supply device 10 is installed is referred to as an installation place 100 of an electric outlet 30.

To an electric outlet 30, electricity is supplied from an electricity supplier, such as an electricity company. Also, to an electric outlet 30, a vehicle 20 of a user can be electrically connected using a charging cable. Each vehicle 20 may be an electric vehicle, a hybrid vehicle, or the like that includes an electric motor for generating vehicle drive power, and a secondary battery for storing electricity used to drive the electric motor. Electricity is supplied to a vehicle 20 through an electric outlet 30, and the secondary battery mounted on the vehicle 20 is charged up therewith. Each control device 32 performs wired communication or wireless communication with the management server 18 and the fee charging server 12, and also controls the electricity supply through a corresponding electric outlet 30.

The fee charging server 12 may be installed in a data center of an electricity supplier, for example. The fee charging server 12 derives an electricity fee for electricity supplied from an electricity supplier to the installation place 100 of an electric outlet 30. The electricity fee thus derived includes a fee for electricity supplied to a vehicle 20 through the electric outlet 30, and a fee for electricity consumed for electrical equipment other than the electricity supply device 10. The derived electricity fee is charged to the manager of the installation place 100 of the electric outlet 30.

The manager terminals 16 are terminals used by managers. The manager terminals 16 may be mobile terminals, such as smartphones, cellular phones, tablet terminals, notebook computers, and wearable terminals, or may be stationary terminals, such as personal computers.

Each manager terminal 16 performs wireless communication with the management server 18. Each manager terminal 16 accepts an entry of a use condition for an electric outlet 30 by a manager. In other words, the manager sets a use condition for the electric outlet 30. The manager terminal 16 then transmits the use condition thus accepted to the management server 18. The use condition includes a unit price used for charging to a user. Other use conditions may be further included, such as at least one of an available time of the electric outlet 30 and an available user's grade. When an available time of the electric outlet 30 is included, use of the electric outlet 30 at a time other than the available time is inhibited. When an available user's grade is included, use of the electric outlet 30 by a user whose grade is lower than the available grade is inhibited.

The management server 18 may be installed in a data center, for example, and functions as an information processing device for processing information transmitted from the multiple user terminals 14, multiple manager terminals 16, and the multiple electricity supply devices 10 to perform user authentication processing, payment processing, billing processing, and the like. The management server 18 retains use conditions transmitted respectively from the multiple manager terminals 16. The configuration of the management server 18 will be described later.

The user terminals 14 are owned by the users of the vehicles 20. The user terminals 14 may be mobile terminals, such as smartphones, cellular phones, tablet terminals, notebook computers, and wearable terminals, or may be vehicle-mounted terminals configured as car navigation systems, for example.

Each user terminal 14 performs wireless communication with the management server 18. Based on information received from the management server 18, each user terminal 14 displays information regarding multiple electric outlets 30 near the current position, for example. The information regarding an electric outlet 30 includes a position and the like. Each user terminal 14 can accept a user's entry of a use request for an electric outlet 30. The use request includes information for identifying the electric outlet 30 specified by the user, for example. The user terminal 14 then transmits the use request thus accepted to the management server 18. To the use request, information for identifying the user is attached.

According to the use request transmitted from the user terminal 14, the management server 18 transmits an unlocking request to the electricity supply device 10 that includes the electric outlet 30 specified by the user and also transmits the use condition for the electric outlet 30 to the user terminal 14. When a use condition other than the unit price is further set for the electric outlet 30 specified by the user, such as the available time of the electric outlet 30 and the available user's grade, the management server 18 transmits the unlocking request when the use condition other than the unit price is satisfied, and does not transmit the unlocking request when the use condition other than the unit price is not satisfied. A user's grade is determined based on the payment status of the user and the time required to move the vehicle 20 after the completion of battery charge, for example, and is retained in the management server 18.

Upon reception of the unlocking request from the management server 18, the control device 32 unlocks the electric outlet 30. While the electric outlet 30 is locked, even though a vehicle 20 is connected to the electric outlet 30, the control device 32 inhibits electricity supply through the electric outlet 30.

After the transmission of the use request, the user terminal 14 receives the use condition for the specified electric outlet 30 from the management server 18. Accordingly, the user terminal 14 displays the unit price included in the use condition. The user can check the unit price on the user terminal 14 and determine whether to use the specified electric outlet 30. When the user agrees to the unit price, the user connects the vehicle 20 to the electric outlet 30 with a charging cable. When the user cannot agree to the unit price, the user may specify another electric outlet 30.

When the vehicle 20 is connected to the electric outlet 30 while the electric outlet 30 is unlocked, the control device 32 starts electricity supply to the vehicle 20 through the electric outlet 30. When a predetermined period of time elapses after the start of battery charge, when the secondary battery of the vehicle 20 is fully charged, or when the user disconnects the charging cable from the electric outlet 30, for example, the control device 32 terminates the electricity supply to the vehicle 20 through the electric outlet 30.

The control device 32 records charge result information of the vehicle 20 charged up with electricity supplied thereto through the electric outlet 30. The charge result information includes a charging time for which electricity has been supplied to the vehicle 20 through the electric outlet 30. After the completion of the battery charge, the control device 32 transmits the charge result information thus recorded to the management server 18.

Based on the use condition for the electric outlet 30 used for the battery charge up and the charge result information, the management server 18 derives an amount of payment to the manager and an amount charged to the user, and performs payment processing for the amount of payment to the manager and billing processing for the amount charged to the user. The amount of payment to the manager is an amount that compensates for the fee for the electricity supplied to the vehicle 20 through the electric outlet 30. The management server 18 transmits, to the user terminal 14, receipt information for the fee for the battery charge and also transmits, to the manager terminal 16, payment completion information for the amount of payment to the manager.

After the completion of the battery charge, the user terminal 14 receives the receipt information from the management server 18. Also, after the completion of the battery charge, the manager terminal 16 receives the payment completion information from the management server 18.

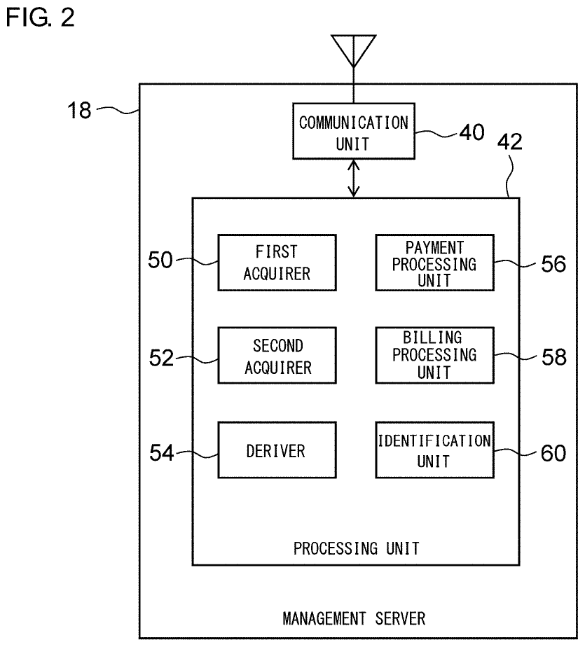

FIG. 2 shows a configuration of the management server 18 shown in FIG. 1. The management server 18 includes a communication unit 40 and a processing unit 42. The processing unit 42 includes a first acquirer 50, a second acquirer 52, a deriver 54, a payment processing unit 56, a billing processing unit 58, and an identification unit 60.

The communication unit 40 performs wireless communication with the multiple user terminals 14. The communication unit 40 also performs wired communication or wireless communication with the multiple manager terminals 16 and the multiple electricity supply devices 10. The communication unit 40 receives the use conditions for the electric outlets 30 respectively from the multiple manager terminals 16 and outputs the use conditions thus received to the processing unit 42. The first acquirer 50 then acquires the use condition for each of the multiple electric outlets 30.

The communication unit 40 receives the use request from a user terminal 14 and outputs the use request thus received to the processing unit 42. According to the information for identifying the user attached to the use request, the processing unit 42 performs user authentication. Upon completion of the user authentication, based on the information for identifying the electric outlet 30 included in the use request, the processing unit 42 transmits, via the communication unit 40, the unlocking request to the electricity supply device 10 that includes the electric outlet 30 specified by the user.

The identification unit 60 identifies, from among the multiple electric outlets 30, the electric outlet 30 specified by the user, through which electricity is to be supplied to the vehicle 20 of the user.

The communication unit 40 transmits, to the user terminal 14, the use condition for the electric outlet 30 specified by the user. Also, the communication unit 40 receives the charge result information from the electricity supply device 10 that includes the electric outlet 30 specified by the user. The second acquirer 52 then acquires the charge result information received at the communication unit 40. This corresponds to acquiring, by the second acquirer 52, the charge result information regarding battery charge using electricity supplied through the electric outlet 30 identified by the identification unit 60.

When the use condition for the identified electric outlet 30 has been set by the manager, the deriver 54 derives the amount of payment to the manager of the installation place of the identified electric outlet 30 and the amount charged to the user, based on the use condition for the identified electric outlet 30 acquired at the first acquirer 50 and the charge result information acquired at the second acquirer 52. For example, the deriver 54 may derive the amount of payment to the manager and the amount charged to the user by substituting the unit price included in the use condition and the charging time included in the charge result information into a predetermined calculation formula. The amount of payment to the manager may be equal to the amount charged to the user, for example.

The payment processing unit 56 performs the payment processing for the derived amount of payment to the manager and transmits the payment completion information to the manager terminal 16 via the communication unit 40. The billing processing unit 58 performs fee charging processing for the derived amount charged to the user and transmits the receipt information to the user terminal 14 via the communication unit 40. The payment processing and the fee charging processing may be performed based on a well-known technology.

The configuration of the processing unit 42 may be implemented by a CPU or memory of any given computer, an LSI, or the like in terms of hardware, and by a memory-loaded program or the like in terms of software. In the present embodiment is shown a functional block configuration realized by cooperation thereof. Therefore, it would be understood by those skilled in the art that these functional blocks may be implemented in a variety of forms by hardware only, software only, or a combination thereof.

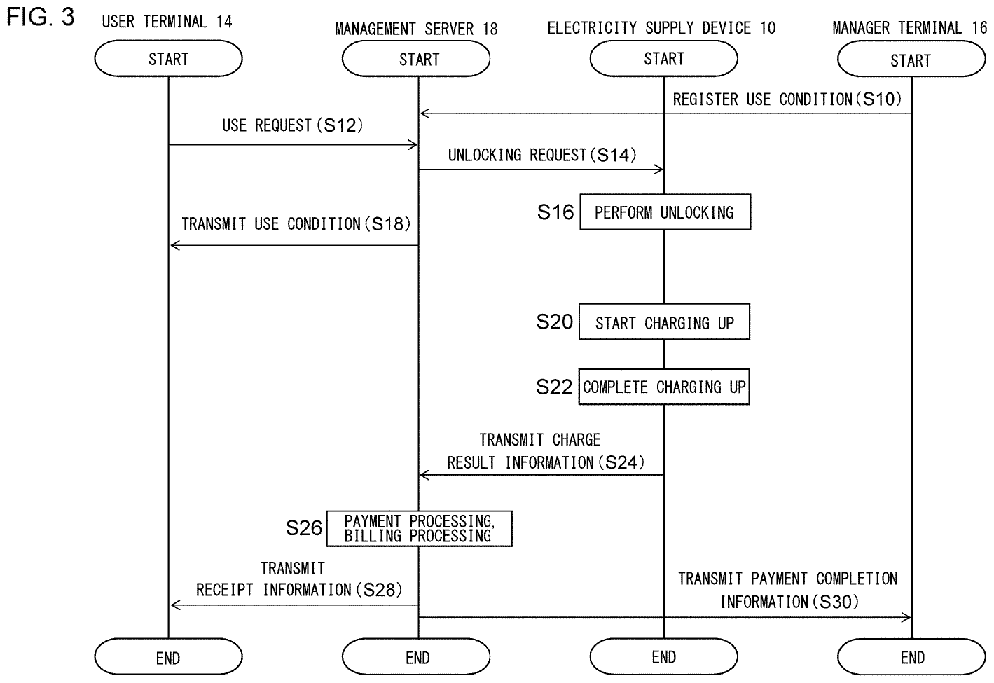

There will now be described the overall operation of the information processing system 1 having the configuration set forth above. FIG. 3 is a sequential diagram that shows processing performed in the information processing system 1 shown in FIG. 1.

A manager terminal 16 registers a use condition in the management server 18 (S10). A user terminal 14 transmits the use request to the management server 18 (S12). According to the use request, the management server 18 transmits the unlocking request to an electricity supply device 10 (S14). According to the unlocking request, the electricity supply device 10 performs unlocking (S16).

The management server 18 transmits the use condition to the user terminal 14 (S18). When the user agrees to the use condition and connects the vehicle 20 to the electric outlet 30 with a charging cable, the electricity supply device 10 starts battery charge of the vehicle 20 (S20). The electricity supply device 10 completes the battery charge up of the vehicle 20 in a predetermined condition (S22). The electricity supply device 10 transmits the charge result information to the management server 18 (S24).

Based on the use condition and the charge result information, the management server 18 derives the amount of payment to the manager and the amount charged to the user, and performs the payment processing and the billing processing (S26). The management server 18 transmits the receipt information to the user terminal 14 (S28) and also transmits the payment completion information to the manager terminal 16 (S30).

According to the present embodiment, since the amount of payment to the manager and the amount charged to the user are derived based on the use condition for the electric outlet 30 and the charge result information, the payment to the manager and the charging to the user can be appropriately performed according to the use condition set by the manager.

For example, if the manager sets the use condition of setting the unit price used for charging to a user to be free, the amount charged to the user will be zero, and the amount of payment to the manager will also be zero. Accordingly, when the installation place of the electric outlet 30 is a store, for example, by bearing the fee for electricity used for battery charge for a user, the manager may be able to acquire a person who was riding the vehicle 20, which is currently charged up, as a customer of the store.

Also, if the manager sets the use condition of setting the unit price used for charging to a user higher than the contract unit price of electricity supply between an electricity supplier and the manager, the amount charged to the user will be equal to the amount of payment to the manager, which is higher than the electricity fee charged by the electricity supplier to the manager. Accordingly, the manager can make a profit. Such a situation may be, for example, the case where the installation place of the electric outlet 30 is a house with a parking space, and the manager wishes to make a profit using the parking space.

Since the use condition includes a unit price used for charging to a user and set for each time period, the manager can flexibly determine the fee based on the reason for installing the electric outlet 30. For example, in the nighttime for which a store is closed, a person who was riding the vehicle 20, which is currently charged up, cannot be a customer of the store. Accordingly, the manager of the store may set the unit price in the nighttime higher than that in the daytime for which the store is open.

Also, when the communication unit 40 transmits the use condition to a user terminal 14, electricity supply through the electric outlet 30 is started upon connection of the vehicle 20 to the electric outlet 30. Therefore, a vehicle 20 of a user who has agreed to the use condition can be charged up.

### Second Embodiment

The second embodiment differs from the first embodiment in that a use condition is set by the owner of the management server 18, i.e., the provider of the battery charging service. In the following, description will be given mainly for the differences from the first embodiment.

A control device 32 acquires, from the fee charging server 12, contract information regarding electricity supply between an electricity supplier and the manager of the installation place 100 of the electric outlet 30 and retains the contract information thus acquired. When the control device 32 already retains the contract information, the control device 32 need not necessarily acquire the contract information from the fee charging server 12. The contract information includes a contract unit price, which is a fee per unit electricity. The contract unit price may be set for each time period. The control device 32 transmits the retained contract information to the management server 18.

When a user terminal 14 receives a use condition for an electric outlet 30, the user terminal 14 accepts a user's entry of agreement to the use condition and transmits agreement information to the management server 18.

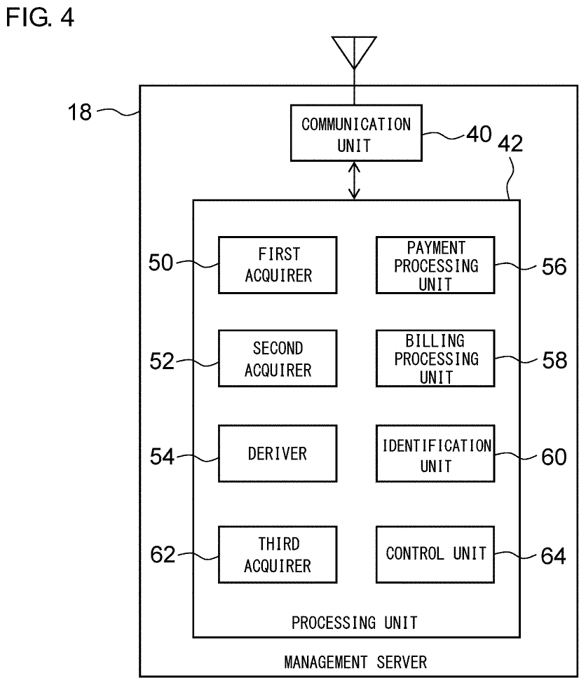

FIG. 4 shows a configuration of the management server 18 according to the second embodiment. The processing unit 42 further includes a third acquirer 62 and a control unit 64. The communication unit 40 receives the contract information from the electricity supply device 10 that includes the electric outlet 30 specified by the user. The third acquirer 62 then acquires the contract information regarding the electric outlet 30 specified by the user received at the communication unit 40.

When the communication unit 40 receives from the user terminal 14 the agreement information regarding the user's agreement to the use condition, the control unit 64 transmits electricity supply permission information to the electricity supply device 10 via the communication unit 40 to permit electricity supply through the electric outlet 30. When the communication unit 40 does not receive the agreement information, the control unit 64 does not transmit the electricity supply permission information and inhibits the electricity supply. Accordingly, the control device 32 of the electricity supply device 10 allows electricity supply through the electric outlet 30 when receiving the electricity supply permission information, and does not allow the electricity supply when not receiving the electricity supply permission information.

When the use condition for the electric outlet 30 identified by the identification unit 60 has been set by the owner of the management server 18, the deriver 54 derives the amount charged to the user based on the use condition and the charge result information, and also derives the amount of payment to the manager based on the contract information acquired at the third acquirer 62 and the charge result information.

For example, if the owner of the management server 18 sets the use condition of setting the unit price used for charging to a user to be free as a campaign or the like, the amount charged to the user will be free. The amount of payment to the manager is an amount corresponding to the electricity fee charged by the electricity supplier to the manager. Accordingly, when the installation place of the electric outlet 30 is a store, for example, the manager may be able to acquire a person who was riding the vehicle 20, which is currently charged up, as a customer of the store, without bearing the fee for electricity used for the battery charge.

Also, if the owner of the management server 18 sets the use condition of setting the unit price used for charging to a user higher than the contract unit price in the contract information, the amount charged to the user will be higher than the amount of payment to the manager. The amount of payment to the manager will be an amount corresponding to the electricity fee charged by the electricity supplier to the manager. Accordingly, the owner of the management server 18 can make a profit without causing the manager to bear the fee for electricity used for the battery charge.

According to the present embodiment, since the amount charged to the user is derived based on the use condition for the electric outlet 30 and the charge result information, the charging to the user can be appropriately performed according to the use condition set by the owner of the management server 18. Also, since the amount of payment to the manager is derived based on the contract information and the charge result information, the manager can be compensated with an appropriate amount corresponding to the electricity fee charged by the electricity supplier to the manager.

Also, since electricity supply through the electric outlet 30 is permitted in response to the agreement information regarding the user's agreement to the use condition accepted at the user terminal 14, a vehicle 20 of a user who has agreed to the use condition can be charged up.

### Third Embodiment

The third embodiment differs from the first embodiment in that a user is charged a flat-rate fee. In the following, description will be given mainly for the differences from the first embodiment.

The billing processing unit 58 performs billing processing of a predetermined amount of fee for each of multiple users at predetermined timing. The predetermined timing may be once a month, for example. In this case, billing processing of a monthly flat-rate fee will be performed.

When the use condition for the electric outlet 30 identified by the identification unit 60 meets a predetermined condition, the deriver 54 derives the amount of payment to the manager of the installation place 100 of the electric outlet 30 based on the use condition and the charge result information.

The use condition for the electric outlet 30 is set by the manager. Meanwhile, the predetermined condition is set by the owner of the management server 18 and may be that the available time of the electric outlet 30 is 24 hours and the unit price used for charging to a user is a predetermined amount or lower, for example. Also, the predetermined condition may be that the available time of the electric outlet 30 includes the nighttime and the unit price used for charging to a user is a predetermined amount or lower.

When the use condition for the electric outlet 30 identified by the identification unit 60 does not meet the predetermined condition, the deriver 54 derives the amount of payment to the manager of the installation place 100 of the electric outlet 30 based on the charge result information. For example, based on the charge result information for each of multiple electric outlets 30 acquired at the second acquirer 52, the deriver 54 may distribute an amount corresponding to the total amount of fees of which billing processing has been performed for multiple users, among the managers of the installation places 100 of the respective electric outlets 30, and may set the amount distributed to each manager as the amount of payment to the manager. The amount of payment for the case where the use condition does not meet the predetermined condition is set lower than that for the case where the use condition meets the predetermined condition.

According to the present embodiment, a manager who sets the use condition to meet the predetermined condition is treated more preferentially in terms of financial aspects than other managers. Therefore, an electric outlet 30 with a use condition that can improve users' convenience can be provided, while flat-rate pricing is employed for the charging to users.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

For example, in the first through third embodiments, when a solar power system is installed in the installation place 100 of the electric outlet 30, the electricity supply device 10 may preferentially supply electricity generated in the solar power system to the vehicle 20. Also, when an electricity storage system is installed in the installation place 100, the electricity supply device 10 may preferentially supply electricity of the storage battery charged up using midnight electricity or the like to the vehicle 20. This modification improves the benefit of the manager.

In the first embodiment, the processing unit 42 may include the control unit 64 of the second embodiment. In the second embodiment, on the other hand, the processing unit 42 need not include the control unit 64 and, when the communication unit 40 transmits the use condition to a user terminal 14, the control device 32 may start electricity supply through the electric outlet 30 upon connection of the vehicle 20 to the electric outlet 30, in the same way as in the first embodiment. These modifications allow greater flexibility in the configuration of the information processing system 1.

In the first through third embodiments, the charge result information may include the amount of electricity supplied to the vehicle 20 through the electric outlet 30. In this case, in the first embodiment, the deriver 54 may derive the amount of payment to the manager and the amount charged to the user by substituting the unit price included in the use condition and the amount of electricity included in the charge result information into a predetermined calculation formula. This modification allows greater flexibility in the configuration of the information processing system 1.

What is claimed is:

1. A management server, comprising:
a first acquirer configured to acquire a use condition for each of a plurality of electric outlets;
an identification unit configured to identify an electric outlet through which electricity is supplied to a vehicle of a user;
a second acquirer configured to acquire charge result information of the vehicle charged up with electricity supplied through the identified electric outlet; and
a deriver configured to derive at least one of an amount of payment to a manager of the installation place of the identified electric outlet and an amount charged to the user, on the basis of the use condition for the identified electric outlet acquired at the first acquirer and the charge result information acquired at the second acquirer.

2. The management server of claim 1, wherein, when the use condition for the identified electric outlet has been set by the manager, the deriver derives the amount of payment to the manager and the amount charged to the user on the basis of the use condition and the charge result information.

3. The management server of claim 1, further comprising a third acquirer configured to acquire contract information regarding electricity supply between an electricity supplier for supplying electricity to the identified electric outlet and the manager, wherein,
when the use condition for the identified electric outlet has been set by an owner of the management server, the deriver derives the amount charged to the user on the basis of the use condition and the charge result information, and also derives the amount of payment to the manager on the basis of the contract information acquired at the third acquirer and the charge result information.

4. The management server of claim 1, wherein the use condition includes a unit price used for charging to the user and set for each time period.

5. The management server of claim 1, further comprising:
a communication unit configured to transmit the use condition for an electric outlet specified by the user, to a user terminal owned by the user; and
a control unit configured to permit electricity supply through the electric outlet when the communication unit receives, from the user terminal, agreement information regarding the user's agreement to the use condition.

6. An information processing method, comprising:
first acquiring of acquiring a use condition for each of a plurality of electric outlets;
identifying an electric outlet through which electricity is supplied to a vehicle of a user;
second acquiring of acquiring charge result information of the vehicle charged up with electricity supplied through the identified electric outlet; and
deriving at least one of an amount of payment to a manager of the installation place of the identified electric outlet and an amount charged to the user, on the basis of the use condition for the identified electric outlet acquired in the first acquiring and the charge result information acquired in the second acquiring.

7. An information processing system, comprising:
a plurality of electricity supply devices; and
a management server configured to communicate with the plurality of electricity supply devices,
each of the plurality of electricity supply devices comprising:
an electric outlet supplied with electricity from an electricity supplier; and
a control device configured to record charge result information of a vehicle of a user charged up with electricity supplied through the electric outlet, the management server comprising:
a first acquirer configured to acquire a use condition for each of a plurality of electric outlets of the plurality of electricity supply devices;
an identification unit configured to identify an electric outlet through which electricity is supplied to the vehicle;
a second acquirer configured to acquire the charge result information from the control device for the identified electric outlet; and
a deriver configured to derive at least one of an amount of payment to a manager of the installation place of the identified electric outlet and an amount charged to the user, on the basis of the use condition for the identified electric outlet acquired at the first acquirer and the charge result information acquired at the second acquirer.

8. The information processing system of claim 7, wherein:
the management server further comprises a communication unit configured to transmit the use condition for an electric outlet specified by the user, to a user terminal owned by the user; and,
when the communication unit transmits the use condition, the control device starts electricity supply through the electric outlet upon electrical connection of the vehicle to the electric outlet.
